(19) United States
(12) Patent Application Publication
(10) Pub. No.: US 2011/0145172 A1
(43) Pub. Date: Jun. 16, 2011

(54) Prior art

(76) Inventor: William George Bentz, Laurel, MD (US)

(21) Appl. No.: 12/803,736

(22) Filed: Jul. 2, 2010

Related U.S. Application Data
(60) Provisional application No. 61/281,572, filed on Nov. 19, 2009.
(60) Provisional application No. 61/275,952, filed on Sep. 4, 2009.
(60) Provisional application No. 61/271,528, filed on Jul. 22, 2009.
(60) Provisional application No. 61/270,048, filed on Jul. 2, 2009.

(51) Int. Cl. G06Q 90/00

(52) U.S. Cl. 705/500

(57) ABSTRACT

At least a primary prior art, a secondary prior art and a combination of at least a teaching of the primary prior art or any part thereof in view of at least a teaching of the secondary prior art or any part thereof are relied upon, for example, to anticipate under 35 U.S.C. §102 and/or make obvious under 35 U.S.C. §103 a plurality of patent claims. Each of the primary prior art and the secondary prior art is, for example, any prior art (e.g., any prior art reference) charged to PHOSITA under 35 U.S.C. §103. All prior art references, for example, charged to PHOSITA under 35 U.S.C. §103 have been incorporated by reference in their entireties herein.

### PRIOR ART

This application claims the benefit of U.S. Provisional Application No. 61/281,572, filed Nov. 19, 2009, U.S. Provisional Application No. 61/275,952, filed Sep. 4, 2009, U.S. Provisional Application No. 61/271,528, filed Jul. 22, 2009, and U.S. Provisional Application No. 61/270,048, filed Jul. 2, 2009, all of which are hereby incorporated by reference in their entireties.

### DESCRIPTION OF BACKGROUND INFORMATION

“Unpatentability in view of the prior art” is “by far the most frequent ground of rejection,” according to MPEP §706.02. Patent claims to be allowed and/or not invalidated, for example, must be novel under 35 U.S.C. §102 and nonobvious under 35 U.S.C. §103.

### BRIEF DESCRIPTION OF THE DRAWINGS

FIGS. 1-2 depict a reference;

FIGS. 3-4 depict a plurality of exemplary combinations;

FIGS. 5-6 depict a plurality of exemplary references to apply for a first reference, a second reference, a third reference and/or a fourth reference depicted in FIGS. 3 and/or 4; and

FIG. 7 depicts an exemplary embodiment of a method.

### DETAILED DESCRIPTION

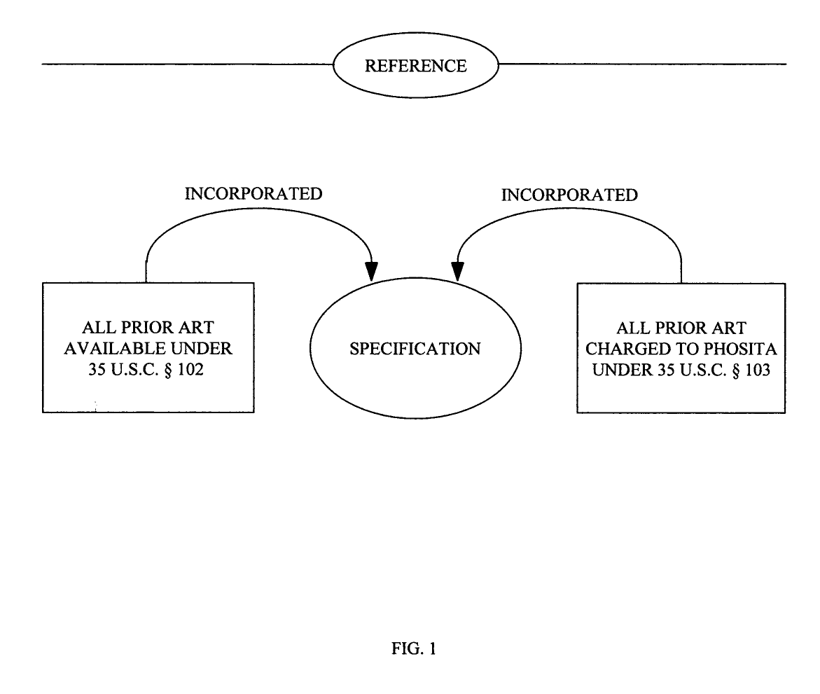

As illustrated in FIG. 1, all prior art (e.g., all prior art references) available under 35 U.S.C. §102 and all prior art (e.g., all prior art references) charged to any person having ordinary skill in the art (“PHOSITA”) under 35 U.S.C. §103 are hereby incorporated by reference in their entireties herein. The reference of FIG. 1, for example, is a living, breathing document.

The reference of FIG. 1 may be a printed reference (e.g., a hard copy) and/or an electronic reference. The reference may be a patent application and/or a patent. Also, (1) the prior art references available under 35 U.S.C. §102 of FIG. 1 and (2) the prior art references charged to PHOSITA under 35 U.S.C. §103 of FIG. 1 are, for example, publications (e.g., printed publications and/or electronic publications) and/or documents (e.g., printed documents and/or electronic documents).

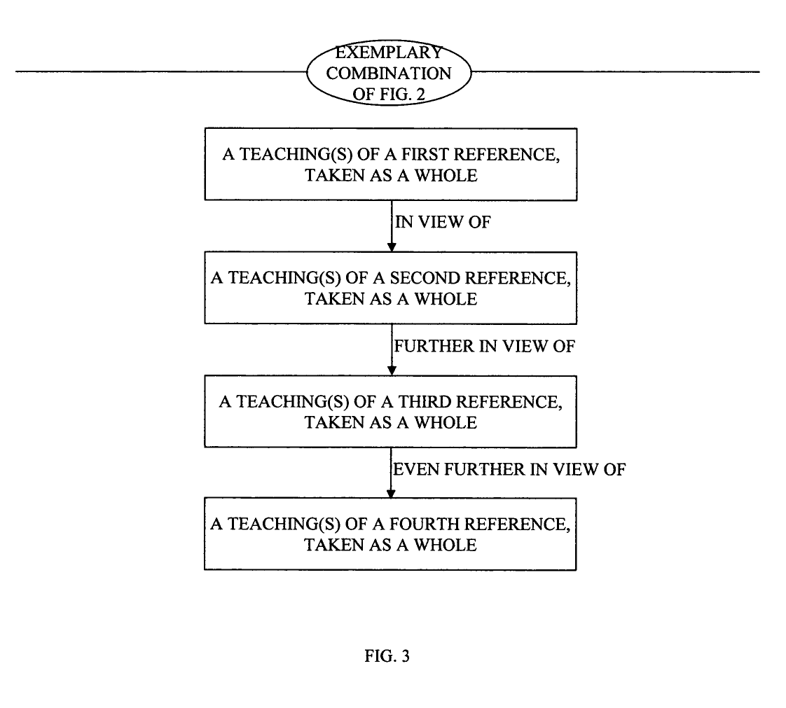

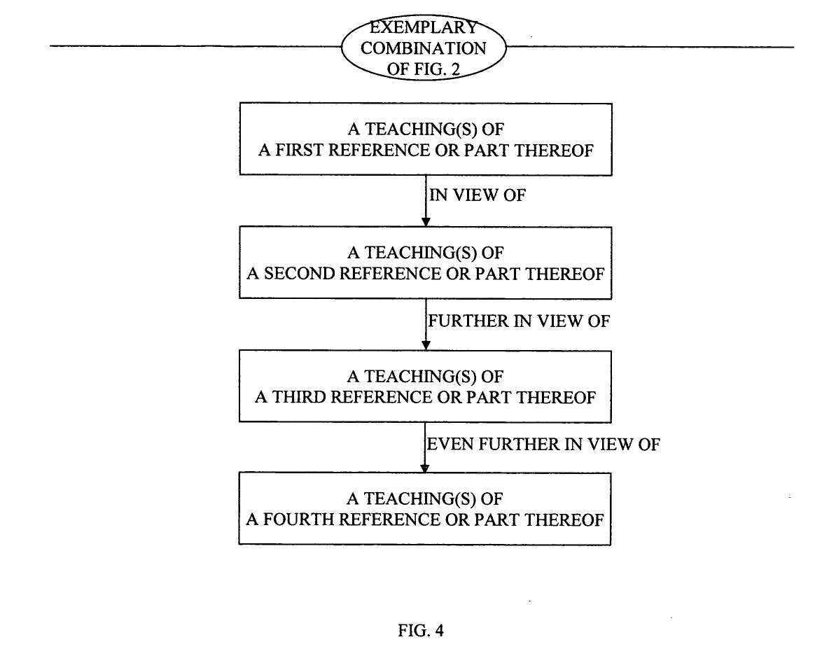

The reference of FIG. 1 may be relied upon in any and/or all patent proceedings, including patent counseling, patent prosecution, patent licensing, patent reexamination, patent reissue, patent litigation, patent arbitration and/or patent mediation. The reference may be relied upon as prior art, for example, to reduce a backlog of patent applications to be examined at the U.S. Patent and Trademark Office (“USPTO”) and/or speed the patent prosecution process at the USPTO. The reference may also be relied upon to enhance quality and/or productivity at the USPTO. The reference, for example, may provide more freedom of operation and/or more patent cost reduction (e.g., patent litigation cost reduction) to companies, firms, individuals and/or others (e.g., assignees and/or applicants identified in U.S. patents and U.S. published patent applications). For example, the reference may provide more freedom to make, use, sell and/or other (e.g., offer to sell) a machine (e.g., an apparatus), a process (e.g., a method), a composition of matter, an article of manufacture and/or other (e.g., a design, a plant, etc.) that, for example, may be depicted (in whole or in part) by FIGS. 3 and 4. The reference may be relied upon to at least one of (1) reject a patent claim(s), (2) invalidate a patent claim(s), (3) support a patent claim(s) and (4) strengthen a patent claim(s). The reference may also be relied upon to defend a patent litigation and/or settle a patent proceeding(s).

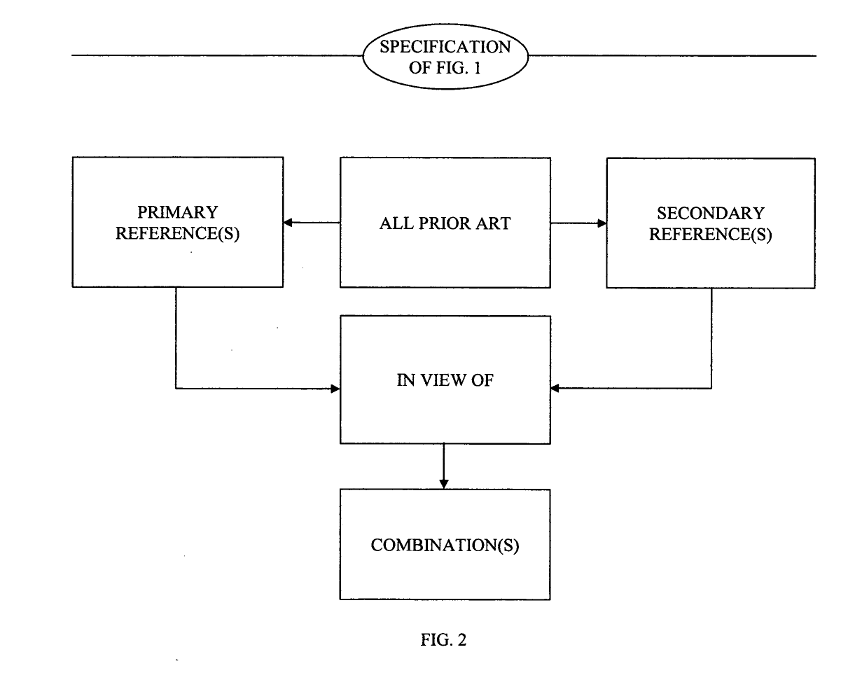

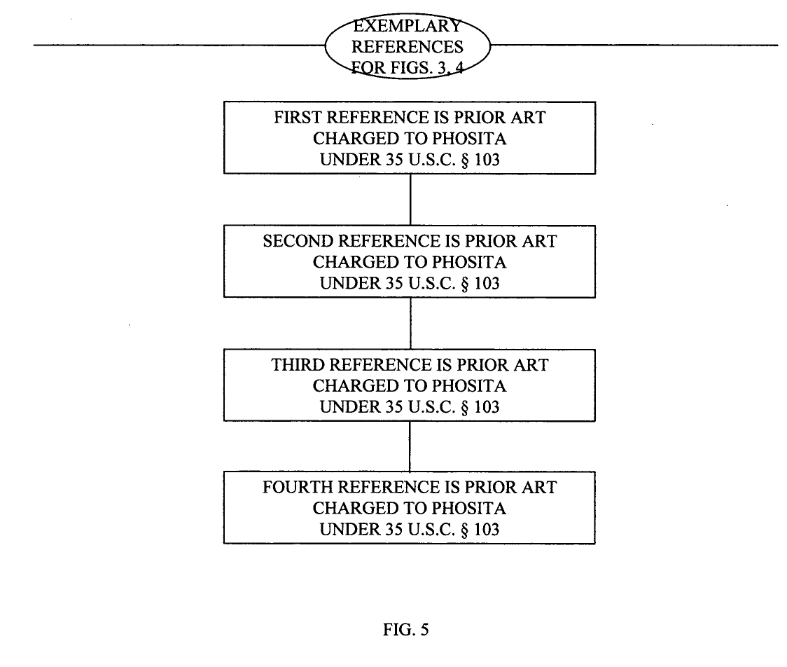

The reference (see, for example, FIGS. 2-6) includes a combination of at least a first teaching(s) of a primary prior art or any part thereof in view of (e.g., combined with and/or modified by) at least a second teaching(s) of a secondary prior art or any part thereof. Each of the primary prior art and the secondary prior art is, for example, any prior art (e.g., any prior art reference) charged to PHOSITA under 35 U.S.C. §103, as illustrated in FIG. 5. All prior art references, for example, charged to PHOSITA under 35 U.S.C. §103 have been incorporated by reference in their entireties herein. PHOSITA under 35 U.S.C. §103, for example, is charged with knowledge of all analogous prior art.

Each prior art (e.g., each prior art reference) charged to PHOSITA under 35 U.S.C. §103 may be applied (e.g., one at a time) as each of the primary prior art and the secondary prior art. Each prior art (e.g., each prior art reference) charged to PHOSITA under 35 U.S.C. §103 may also be applied (e.g., one at a time) as the primary prior art, and any different prior art (e.g., any different prior art reference) charged to PHOSITA under 35 U.S.C. §103 may then be applied (e.g., one at a time) as the secondary prior art.

The first teaching(s) and the second teaching(s) may be combined so as to make improvements, substitutions, additions, deletions, combinations and/or other modifications to the first teaching(s) or any part thereof. For example, an embodiment or any part thereof from a primary reference may be combined with and/or modified by an embodiment or any part thereof from a secondary reference. The combination, for example, may transform specific data representing a specific physical object and/or substance.

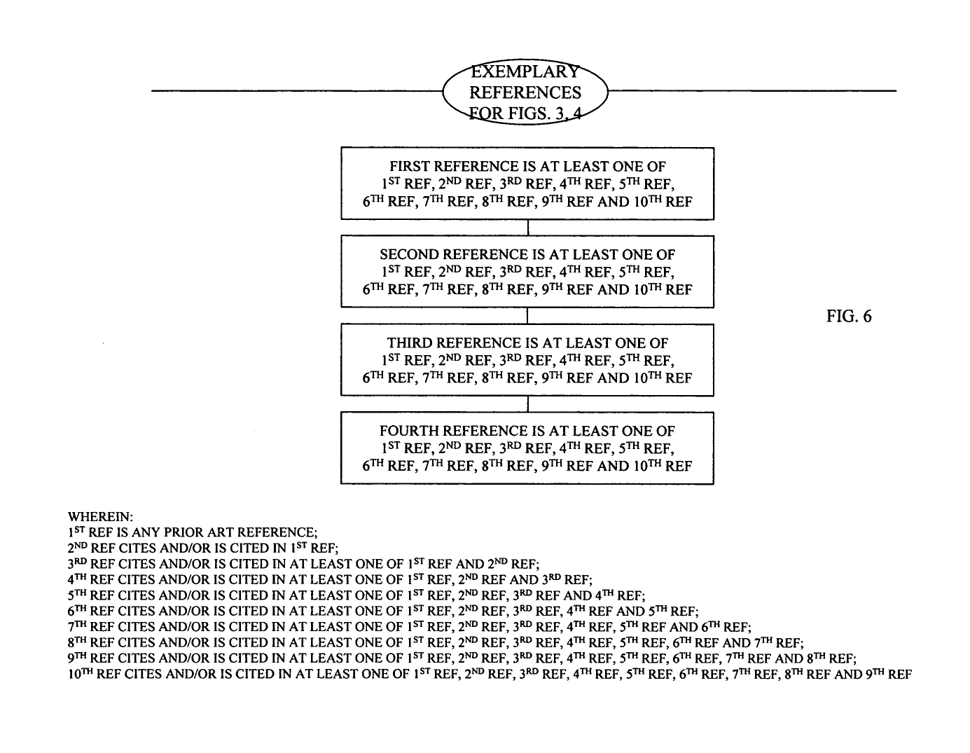

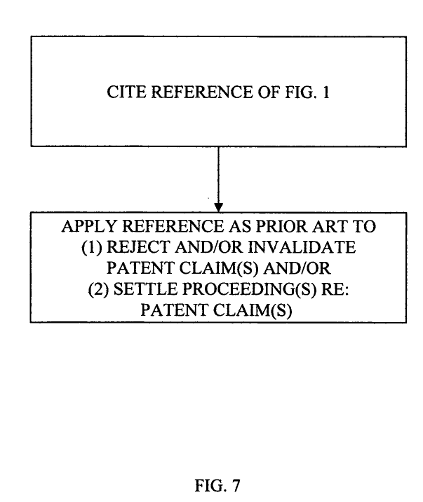

The primary prior art may be any prior art reference available under 35 U.S.C. §102, whereas the secondary prior art may be any reference citing and/or cited in the primary prior art, for example, as illustrated in FIG. 6. The secondary prior art may also be any reference citing (or not) and/or cited in (or not) the primary prior art. Each reference citing (or not) and/or cited in (or not) the primary prior art may be applied (e.g., one at a time) as the secondary prior art.

The number of REFs in FIG. 6 may be any number. For example, each of the first reference, the second reference, the third reference and the fourth reference depicted in FIG. 6 may be at least one of a 1^{st} ref, a 2^{nd} ref, a 3^{rd} ref, a 4^{th} ref and a 5^{th} ref as depicted in FIG. 6.

The reference of FIG. 1, for example, considers each of the primary prior art and the secondary prior art in its entirety, as illustrated in FIG. 3. The reference of FIG. 1 also, for example, considers each of the primary prior art and the secondary prior art in less than its entirety, as illustrated in FIG. 4.

Any subject matter (e.g., any teaching(s), at least a teaching(s), etc.) from the primary prior art may be applied as the first teaching(s) of the primary prior art and any subject matter (e.g., any teaching(s), at least a teaching(s), etc.) from the secondary prior art may be applied as the second teaching(s) of the secondary prior art. For example, the primary prior art (taken as a whole) and/or the secondary prior art (taken as a whole) may argue against and/or teach away from the combination of at least the first teaching(s) of the primary prior art or any part thereof in view of at least the second teaching(s) of the secondary prior art or any part thereof. The first teaching(s) and the second teaching(s), for example, may not include (1) a part (e.g., a teaching(s)) of the primary prior art and/or a part (e.g., a teaching(s)) of the secondary prior art arguing against and/or teaching away from the combination of the first teaching(s) and the second teaching(s) and/or (2) a part (e.g., a teaching(s)) of the primary prior art and/or a part (e.g., a teaching(s)) of the secondary prior art that criticizes, discredits and/or otherwise discourages the combination of the first teaching(s) and the second teaching(s).

The number of teachings and/or references to be combined, for a combination of teachings of references, may be any number (see, for example, FIGS. 2-6). The length of time between the publication dates of the primary reference and the secondary reference may be any time such as, for example, a shorter time (e.g., 0.5, 1, 2, etc. years) and/or a larger time (e.g., 25, 75, 125, etc. years). A combination of teachings of references may be directed to a machine (e.g., an apparatus), a process (e.g., a method), a composition of matter, an article of manufacture and/or other (e.g., a design, a plant, etc.), for example, as identified in any of the claim preambles of patents and patent applications incorporated by reference herein. The combination of teachings of references may be open ended (e.g., comprising the teachings of references) and/or closed ended (e.g., consisting of the teachings of references).

Patentable claims, supported by the specification of FIG. 1, may be presented for examination. The reference of FIG. 1 (in whole or in part) may also be applied as prior art and/or the prior art charged to PHOSITA under 35 U.S.C. §103 may be relied upon, for example, so as to reject and/or invalidate patent claims (e.g., pending patent claims and/or issued patent claims) as at least one of (1) anticipated under 35 U.S.C. §102 and (2) obvious under 35 U.S.C. §103. The patent claims may be directed to statutory subject matter, for example, under 35 U.S.C. §101 (utility), 35 U.S.C. §171 (design) and/or 35 U.S.C. §161 (plant). The patent claims may be directed to the electrical arts, mechanical arts, chemical arts, design arts and/or other arts (e.g., useful arts, technological arts, industrial application, etc.). Each patent claim may be directed to a machine (e.g., an apparatus), a process (e.g., a method), a composition of matter, an article of manufacture and/or other (e.g., design, plant, etc.), for example, as identified in any of the claim preambles of patents and patent applications incorporated by reference herein.

All prior art (e.g., all prior art references) available under 35 U.S.C. §102 is hereby incorporated by reference in its entirety, as illustrated in FIG. 1. For example, all prior art references available under 35 U.S.C. §102 (e.g., 35 U.S.C. §102(b)) are hereby incorporated by reference in their entireties. Also, all prior art (e.g., all prior art references) charged to any and/or all PHOSITAs under 35 U.S.C. §103 is hereby incorporated by reference in its entirety.

For example, (1) all patents and all patent applications published by each and every patent office, including the USPTO and the EPO (which, for example, publishes EP patents and WO patents), (2) all references cited in the patents and the patent applications published by each and every patent office, (3) 35 U.S.C., including 35 U.S.C. §§101, 102, 103, 161 and 171 and (3) all prior art references charged to any and/or all PHOSITAs under 35 U.S.C. §103, all of which are hereby incorporated by reference in their entireties. Patents and/or patent applications, for example, are published online by the USPTO (http://www.uspto.gov) and the EPO (http://ep.espacenet.com/).

The U.S. patents published by the USPTO and incorporated by reference herein include:

| U.S. Patents | Utility | Design | Plant |
|---|---|---|---|
| 1976-present | 3,930,271- | D242,583- | PP3,987- |
| | 7,748,052 | D618,875 | PP21,134 |
| 1790-1975 | X1-X11,280; | D1-D242,880 | PP1-P4,000 |
| | 1-3,930,270 | | |

The USPTO provides a list of missing U.S. patents and withdrawn U.S. patents. The U.S. patent applications published by the USPTO and incorporated by reference herein include: U.S. published patent application nos. 20010000001-20100170020.

FIGS. 2-6 include a combination of a teaching(s) from a primary reference(s) and a teaching(s) from a secondary reference(s), where the primary reference(s) and the secondary reference(s) may be different references (or not). The combination, for example, may modify an embodiment of a machine or any part thereof, an embodiment of a process or any part thereof, an embodiment of a composition of matter or any part thereof, an embodiment of an article of manufacture or any part thereof, an embodiment of a design or any part thereof and/or other (e.g., plant).

FIG. 3 illustrates an exemplary combination of at least a teaching(s) of a first reference (taken as a whole) in view of at least a teaching(s) of a second reference (taken as a whole), and further in view of at least a teaching(s) of a third reference (taken as a whole), and even further in view of at least a teaching(s) of a fourth reference (taken as a whole). FIG. 3, for example, considers each of (1) the first reference, (2) the second reference, (3) the third reference and (4) the fourth reference in whole.

FIG. 4 illustrates an exemplary combination of at least a teaching(s) of a first reference or any part thereof in view of at least a teaching(s) of a second reference or any part thereof, and further in view of at least a teaching(s) of a third reference or any part thereof, and even further in view of at least a teaching(s) of a fourth reference or any part thereof. FIG. 4, for example, considers each of (1) the first reference, (2) the second reference, (3) the third reference and (4) the fourth reference in part.

Any subject matter (e.g., any teaching(s), at least a teaching(s), etc.) from the first reference or any part thereof may be applied as the teaching(s) of the first reference of FIG. 4, any subject matter (e.g., any teaching(s), at least a teaching(s), etc.) from the second reference or any part thereof may be applied as the teaching(s) of the second reference of FIG. 4, any subject matter (e.g., any teaching(s), at least a teaching(s), etc.) from the third reference or any part thereof may be applied as the teaching(s) of the third reference of FIG. 4 and any subject matter (e.g., any teaching(s), at least a teaching(s), etc.) from the fourth reference or any part thereof may be applied as the teaching(s) of the fourth reference of FIG. 4.

FIGS. 5-6 provide a plurality of exemplary references that may be applied for the first reference, the second reference, the third reference and/or the fourth reference depicted in FIGS. 3 and/or 4. Each of the first reference, the second reference, the third reference and the fourth reference of FIGS. 3 and 4, for example, is (or is not) prior art incorporated by reference herein.

Each of the first reference, the second reference, the third reference and the fourth reference, for example, is any prior art reference (e.g., at least a prior art reference) charged to PHOSITA under 35 U.S.C. §103, as illustrated in FIG. 5. Each of the first reference, the second reference, the third reference and the fourth reference may be any analogous prior art reference. PHOSITA under 35 U.S.C. §103, for example, is charged with knowledge of all analogous prior art references. Any prior art reference (e.g., at least a prior art reference) charged to PHOSITA under 35 U.S.C. §103 may be applied as each of the first reference, the second reference, the third reference and/or the fourth reference. Any other prior art reference charged to PHOSITA under 35 U.S.C. §103 may also be applied as the second reference, any other different prior art reference charged to PHOSITA under 35 U.S.C. §103 may further be applied as the third reference and any other different prior art reference charged to PHOSITA under 35 U.S.C. §103 may even further be applied as the fourth reference.

FIG. 6 depicts that each of the first reference, the second reference, the third reference and the fourth reference is at least one of a 1^{st} reference, a 2^{nd} reference, a 3^{rd} reference, a 4^{th} reference, a 5^{th} reference, a 6^{th} reference, a 7^{th} reference, a 8^{th} reference, a 9^{th} reference and a 10^{th} reference (all of which are hereby incorporated by reference in their entireties). Prior art references (1) available under 35 U.S.C. §102 and/or (2) charged to PHOSITA under 35 U.S.C. §103 may be applied (e.g., one prior art reference at a time) as the 1^{st} reference.

FIG. 6 depicts that the 1^{st} reference is any prior art reference (e.g., at least a prior art reference); the 2^{nd} reference is any prior art reference citing and/or cited in the 1^{st} reference; the 3^{rd} reference is any prior art reference citing and/or cited in at least one of the 1^{st} reference and the 2^{nd} reference; the 4^{th} reference is any prior art reference citing and/or cited in at least one of the 1^{st} reference, the 2^{nd} reference and the 3^{rd} reference; the 5^{th} reference is any prior art reference citing and/or cited in at least one of the 1^{st reference, the} 2^{nd} reference, the 3^{rd} reference and the 4^{th} reference; the 6^{th} reference is any prior art reference citing and/or cited in at least one of the 1^{st} reference, the 2^{nd} reference, the 3^{rd} reference, the 4^{th} reference and the 5^{th} reference; the 7^{th} reference is any prior art reference citing and/or cited in at least one of the 1^{st} reference, the 2^{nd} reference, the 3^{rd} reference, the 4^{th} reference, the 5^{th} reference and the 6^{th} reference; the 8^{th} reference is any prior art reference citing and/or cited in at least one of the 1^{st} reference, the 2^{nd} reference, the 3^{rd} reference, the 4^{th} reference, the 5^{th} reference, the 6^{th} reference and the 7^{th} reference; the 9^{th} reference is any prior art reference citing and/or cited in at least one of the 1^{st} reference, the 2^{nd} reference, the 3^{rd} reference, the 4^{th} reference, the 5^{th} reference, the 6^{th} reference, the 7^{th} reference and the 8^{th} reference; and the 10^{th} reference is any prior art reference citing and/or cited in at least one of the 1^{st} reference, the 2^{nd} reference, the 3^{rd} reference, the 4^{th} reference, the 5^{th} reference, the 6^{th} reference, the 7^{th} reference, the 8^{th} reference and the 9^{th} reference.

Patentable claims, supported by the specification of FIG. 1, may be presented for examination. The reference (in whole or in part) of FIG. 1 may also be applied as prior art, for example, so as to reject and/or invalidate a plurality of patent claims (which may be patent eligible, for example, under 35 U.S.C. §101, 35 U.S.C. §171 and/or 35 U.S.C. §161) as at least one of (1) anticipated under 35 U.S.C. §102 and (2) obvious under 35 U.S.C. §103. An office communication(s) (e.g., an electronic Office Action and/or a printed Office Action) may be issued, for example, by the USPTO so as to report allowances and/or rejections of patent claims.

The reference or any part thereof of FIG. 1 may be relied upon (e.g., cited, considered, applied, etc.) as prior art, for example, to reduce a backlog of patent applications to be examined at the USPTO and/or speed the examination of patent claims at the USPTO. The reference or any part thereof may also be relied upon to defend a patent litigation and/or settle a patent proceeding(s), including a patent dispute(s).

A single prior art reference includes, for example, all prior art references available under 35 U.S.C. §102. Anticipation under 35 U.S.C. §102 and/or obviousness under 35 U.S.C. §103 of a plurality of patent claims may be based on the single prior art reference, which includes a first combination as illustrated in FIG. 3 and/or a second combination as illustrated in FIG. 4. FIGS. 5-6 depict a plurality of exemplary references to apply for a first reference, a second reference, a third reference and/or a fourth reference of FIGS. 3 and/or 4. The single prior art reference considers the prior art references in their entireties, as illustrated in FIG. 3. Also, the single prior art reference considers the prior art references in less than their entireties, as illustrated in FIG. 4. Each of the combination of FIG. 3 and the combination of FIG. 4, for example, may transform specific data representing a specific physical object and/or substance. An obviousness rejection under 35 U.S.C. §103 may also be based on the single prior art reference, alone or combined with any other prior art.

At least a primary prior art, a secondary prior art and/or a combination of at least a teaching of the primary prior art or any part thereof in view of at least a teaching of the secondary prior art or any part thereof may be relied upon (e.g., cited, considered, applied, etc.), for example, to anticipate under 35 U.S.C. §102 and/or make obvious under 35 U.S.C. §103 a plurality of patent claims. Each of the primary prior art and the secondary prior art is, for example, any prior art charged to PHOSITA under 35 U.S.C. §103. All prior art references charged to PHOSITA under 35 U.S.C. §103, for example, have been incorporated by reference herein. The primary prior art (taken as a whole) or the secondary prior art (taken as a whole) may argue against (or not) and/or teach away (or not) from the combination.

The above description and the drawings are intended to be illustrative, and not restrictive. The reference of FIG. 1 incorporates by reference all references in the “prior art” and/or in the “state of the art” such that, for example, the reference of FIG. 1 is a living, breathing document. The references may be publications (e.g., printed publications and electronic publications) and/or documents (e.g., printed documents and/or electronic documents).

For example, (1) all “prior art” and/or “state of the art” available under the Patent Cooperation Treaty (“PCT'), (2) all “prior art” and/or “state of the art” available under the national laws of any and/or all PCT Contracting States, (3) all “prior art” and/or “state of the art” available under the European Patent Convention (“EPC”) and (4) all “prior art” and/or “state of the art” available under the national laws of any and/or all EPC Contracting States, all of which are hereby incorporated by reference in their entireties (and may be included in “all prior art” of FIG. 2).

The above “prior art,” “35 U.S.C. §101” (patent eligible subject matter), “35 U.S.C. §102” (anticipation), “35 U.S.C. §103” (obviousness), and “PHOSITA under 35 U.S.C. §103” may be replaced, for example, with any international counterpart. For example, (1) prior art may be replaced with “state of the art,” (2) 35 U.S.C. §101 may be replaced with “industrial applicability,” (3) 35 U.S.C. §102 may be replaced with “novelty,” (4) 35 U.S.C. §103 may be replaced with “inventive step” and/or (5) PHOSITA may be replaced with “person skilled in the art.” The specification of FIG. 1, for example, includes (and has incorporated by reference) all references charged to any and/or all persons skilled in the art, for example, under inventive step of EPC.

The “charged” of FIGS. 1 and 5 may be replaced with “imputed” and/or “presumed.” Each “in view of” FIGS. 2-4 may be replaced with at least one of “comprising,” “consisting of,” “the improvement comprising,” “the improvement consisting of” and “characterized by.” The above “analogous prior art” may be replaced with at least one of “relevant prior art,” “pertinent prior art,” “applicable prior art,” “closest prior art” and “related prior art.”

What is claimed is:

1. A method comprising:
providing an electronic patent application including all prior art references charged to a person having ordinary skill in the art under 35 U.S.C. §103; and
combining, through the electronic patent application, teachings of a plurality of the prior art references charged to the person having ordinary skill in the art under 35 U.S.C. §103, so as to anticipate a patent claim under 35 U.S.C. §102 by the electronic patent application.
